(19) United States
(12) Patent Application Publication
(10) Pub. No.: US 2006/0283058 A1
(43) Pub. Date: Dec. 21, 2006

(54) Bracket

(76) Inventor: Richard H. Buchholz, Lambertville, MI (US)

Correspondence Address: RICHARD H. BUCHHOLZ, 6516 BLACK DIAMOND LANE, LAMBERTVILLE, MI, 48144, US

(21) Appl. No.: 11/062,285

(22) Filed: Jun. 20, 2005

(51) Int. Cl. G09F 7/00

(52) U.S. Cl. 40/209

(57) ABSTRACT

This continental tire bracket gets the tire out of the trunk easy. As a retired metal shop teacher, it was very easy for me to design a metal bracket and only drill two (2) holes in the bumper of 2002-2005 Thunderbirds and make their small trunk bigger. Most other cars with a license plate in the bumper can use this bracket, too. No longer is it necessary to spend thousands on fancy bumpers to get Continental Tires on cars.

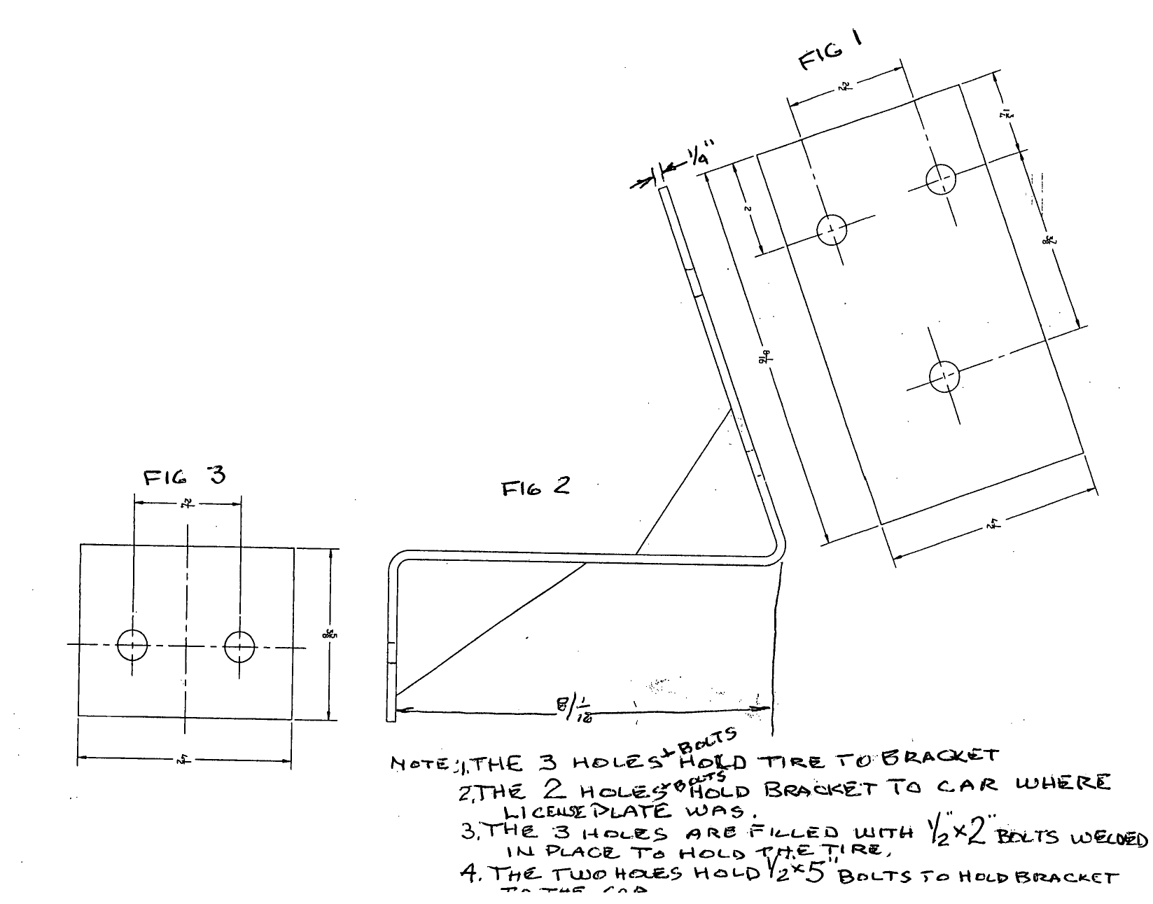

### BRIEF SUMMARY OF THE INVENTION

The trunk of the 2002-2005 is very small. Two grips are too many. I love to travel and I needed more space. I needed to take the spare tire from the trunk to get more space. I'm a retired metal shop teacher, so I made a bracket to put the tire on the back of the car. I had a sample made by a shop teacher friend of mine. It worked on my car, so I had fifty (50) made by a metal company in Toledo, Ohio. I wanted to help myself and other car owners. It will!

1. No one has made an attempt to get a tire out of the trunk like this bracket. Big bumpers were attached to cars to hold tires in the past. This bracket is so easy. Two (2) holes are drilled into the bumper where the license plate was. The bracket is bolted to car. Three (3) other holes are drilled into the bracket to hold bolts to hold the tire. A hard cover is put over the tire and a new license plate holder is attached to the cover and connected to the old license plate light. The tire connected to the bracket causes more room in the trunk. Problem solved.
